(19) United States
(12) Patent Application Publication
(10) Pub. No.: US 2026/0005306 A1
(43) Pub. Date: Jan. 1, 2026

(54) NONAQUEOUS ELECTROLYTE SOLUTION SECONDARY BATTERY

(71) Applicant: Prime Planet Energy & Solutions, Inc., Tokyo (JP)

(72) Inventors: Takehiro OGURA, Kobe-shi (JP); Kentaro TSUKAMOTO, Kobe-shi (JP)

(21) Appl. No.: 19/245,414

(22) Filed: Jun. 23, 2025

(30) Foreign Application Priority Data
Jun. 28, 2024 (JP) 2024-104503

(51) Int. Cl. H01M 10/0567; H01M 4/02; H01M 4/583; H01M 10/0587

(52) U.S. Cl. CPC H01M 10/0567; H01M 4/583; H01M 10/0587; H01M 2004/027

(57) ABSTRACT

A negative electrode of a nonaqueous electrolyte solution secondary battery disclosed herein includes a negative electrode active material layer and a plurality of negative electrode tabs. When a root part of the negative electrode active material layer where the negative electrode tab extends is measured with a spectrometer, an a* value in an L*a*b* color system is 1.3 or less. A value obtained by measuring the amount of carbon element and the amount of boron element by laser ablation ICP mass spectrometry along a width direction of the negative electrode active material layer and integrating a ratio (B/C) of the amount of boron element to the amount of carbon element in the range of ±20 mm from a center in the width direction is 28 or more.

### CROSS REFERENCE TO RELATED APPLICATION

This application claims the benefit of priority to Japanese Patent Application No. 2024-104503 filed on Jun. 28, 2024. The entire contents of this application are hereby incorporated herein by reference.

### BACKGROUND OF THE DISCLOSURE

### 1. Field

The present disclosure relates to a nonaqueous electrolyte solution secondary battery.

### 2. Background

One of the conventionally known nonaqueous electrolyte solution secondary batteries includes an electrode body including a positive electrode and a negative electrode, a positive electrode terminal electrically connected to the positive electrode, a negative electrode terminal electrically connected to the negative electrode, and a nonaqueous electrolyte solution. In the nonaqueous electrolyte solution secondary battery, a part of the nonaqueous electrolyte solution is decomposed typically at initial charging, and a film containing a decomposition product thereof (solid electrolyte interface film: SEI film) is formed on a surface of a negative electrode active material layer. By this film, an interface between the negative electrode active material layer and the nonaqueous electrolyte solution is stabilized (for example, Japanese Patent Application Publication No. 2007-165125).

### SUMMARY

According to the present inventors' examination, in the nonaqueous electrolyte solution secondary battery that has come to have higher capacity in recent years, the electrode body becomes long in width, so that it becomes difficult for the nonaqueous electrolyte solution to permeate to a central part in a width direction. It has been proved that this results in unevenness in quality or quantity of the film in the central part of the negative electrode active material layer and the thermal stability tends to decrease. In addition, in some of the nonaqueous electrolyte solution secondary batteries that have increased in capacity, the negative electrode includes a plurality of negative electrode tabs and these negative electrode tabs are electrically connected to the negative electrode terminal while the negative electrode tabs are stacked and bent. In such a structure, it has been turned out that the quantity or quality of the film tends to vary and the electric resistance (hereinafter referred to as “resistance” simply) tends to become high locally in a root part where the negative electrode tab extends.

The present disclosure has been made in view of the above circumstances, and an object is to provide a nonaqueous electrolyte solution secondary battery in which the resistance of a negative electrode is suppressed and the thermal stability is excellent.

A nonaqueous electrolyte solution secondary battery according to the present disclosure includes an electrode body including a positive electrode and a negative electrode, a positive electrode terminal electrically connected to the positive electrode, a negative electrode terminal electrically connected to the negative electrode, and a nonaqueous electrolyte solution. The negative electrode includes a negative electrode active material layer containing a carbon material and having a width of 200 mm or more, and a plurality of negative electrode tabs provided at one end part in a width direction. The plurality of negative electrode tabs are electrically connected to the negative electrode terminal in a state of being stacked and bent. When a root part of the negative electrode active material layer where the negative electrode tab extends is measured with a spectrometer, an a* value in an L*a*b* color system based on JIS Z8781-4:2013 is 1.3 or less, and a value obtained by measuring the amount of carbon element and the amount of boron element by laser ablation ICP mass spectrometry along the width direction of the negative electrode active material layer and integrating a ratio (B/C) of the amount of boron element to the amount of carbon element in a range of ±20 mm from a center in the width direction is 28 or more.

As a result of the present inventors' earnest examination, it has been found out that a high-resistance part appears as “color unevenness” and therefore can be distinguished based on the a* value in the L*a*b* color system. In addition, it has also been discovered that the amount of heat generation of the battery is in correlation with the B/C ratio obtained by the laser ablation ICP mass spectrometry. Therefore, in the present disclosure, the a* value is adjusted to be the predetermined value or less and the B/C ratio is adjusted to be the predetermined value or more. With the aforementioned structure, the battery in which the resistance of the negative electrode is suppressed and the thermal stability is excellent can be provided.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating a nonaqueous electrolyte solution secondary battery according to an embodiment;

FIG. 2 is a schematic longitudinal cross-sectional view taken along line II-II in FIG. 1;

FIG. 3 is a schematic lateral cross-sectional view taken along line III-III in FIG. 1;

FIG. 4 is a perspective view schematically illustrating an electrode body group attached to a sealing plate;

FIG. 5 is a perspective view schematically illustrating a wound electrode body according to the embodiment;

FIG. 6 is a schematic view illustrating a structure of the wound electrode body according to the embodiment;

FIG. 7A expresses a resistance distribution in Comparative Example 1, FIG. 7B expresses the resistance distribution in Comparative Example 2, and FIG. 7C expresses the resistance distribution in Example;

FIG. 8 is a graph expressing a relation between a resistance ratio in a vicinity of a negative electrode tab, and an a* value;

FIG. 9 is a schematic view of a negative electrode (measurement sample);

FIG. 10A expresses a distribution of a ratio (B/C) in Comparative Example 1, FIG. 10B expresses the distribution of the ratio (B/C) in Comparative Example 2, and FIG. 10C expresses the distribution of the ratio (B/C) in Example; and

FIG. 11 is a graph expressing a relation between an integrated value of the ratio (B/C) of a central part of a negative electrode active material layer, and the amount of heat generation of the battery.

### DETAILED DESCRIPTION OF THE PREFERRED EMBODIMENTS

Hereinafter, some preferred embodiments of the art disclosed herein will be described with reference to the drawings. Note that matters other than matters particularly mentioned in the present specification and necessary for the implementation of the present disclosure (for example, the general configuration and manufacturing process of a nonaqueous electrolyte solution secondary battery that do not characterize the present disclosure) can be grasped as design matters of those skilled in the art based on the prior art in the relevant field. The present disclosure can be implemented on the basis of the disclosure of the present specification and common technical knowledge in the relevant field. Note that in the present specification, the notation “A to B” for a range signifies a value more than or equal to A and less than or equal to B, and is meant to encompass also the meaning of being “more than A” and “less than B”.

In the present specification, the term “nonaqueous electrolyte solution secondary battery” refers to a general electrical energy storage device capable of being repeatedly charged and discharged by transfer of charge carriers between a positive electrode and a negative electrode through a nonaqueous electrolyte solution. The nonaqueous electrolyte solution secondary battery refers to a concept that encompasses a so-called secondary battery such as a lithium ion secondary battery or a nickel hydrogen secondary battery, and moreover a capacitor using a chemical reaction, such as a lithium ion capacitor or a pseudo-capacitor.

### Battery 100

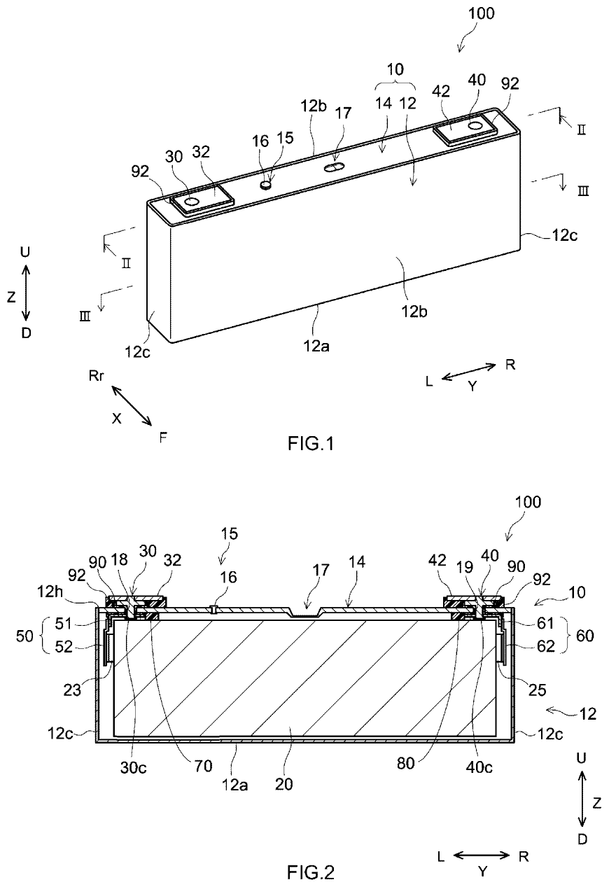

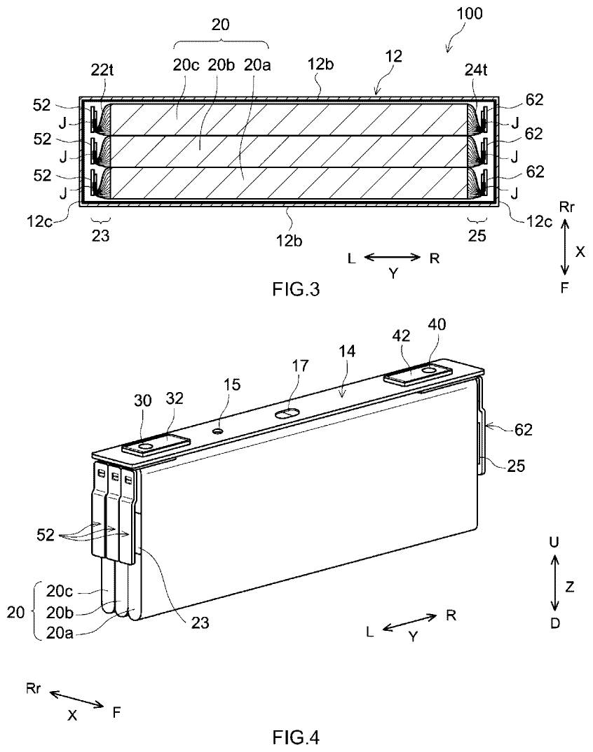

FIG. 1 is a perspective view of a nonaqueous electrolyte solution secondary battery (hereinafter, also referred to as a battery simply) 100. FIG. 2 is a schematic longitudinal cross-sectional view taken along line II-II in FIG. 1. FIG. 3 is a schematic lateral cross-sectional view taken along line III-III in FIG. 1. In the following description, reference signs L, R, F, Rr, U, and D in the drawings respectively denote left, right, front, rear, up, and down, and reference signs X, Y, and Z in the drawings respectively denote a short side direction of the battery 100, a long side direction that is orthogonal to the short side direction, and an up-down direction that is orthogonal to the short side direction and the long side direction. The long side direction Y is one example of a width direction. These directions are defined however for convenience of explanation, and do not limit the manner in which the battery 100 is disposed.

As illustrated in FIG. 2, the battery 100 includes a battery case 10, an electrode body group 20, a positive electrode terminal 30, a negative electrode terminal 40, and a nonaqueous electrolyte solution (not illustrated). The battery 100 here further includes a positive electrode current collecting part 50 and a negative electrode current collecting part 60. The battery 100 is a lithium ion secondary battery here. The battery 100 is preferably the lithium ion secondary battery.

The battery case 10 is a housing that accommodates the electrode body group 20 and the nonaqueous electrolyte solution. As illustrated in FIG. 1, the external shape of the battery case 10 here is a flat and bottomed cuboid shape (rectangular shape). A conventionally used material can be used for the battery case 10, without particular limitations. The battery case 10 is preferably made of a metal, and for example, more preferably made of aluminum, an aluminum alloy, iron, an iron alloy, or the like. As illustrated in FIG. 2, the battery case 10 includes an exterior body 12 having an opening 12h, and a sealing plate (lid body) 14 that covers the opening 12h here.

As illustrated in FIG. 1, the exterior body 12 includes a bottom wall 12a with a substantially rectangular shape, a pair of long side walls 12b extending from long sides of the bottom wall 12a and facing each other, and a pair of short side walls 12c extending from short sides of the bottom wall 12a and facing each other. The bottom wall 12a faces the opening 12h. The long side wall 12b is larger in area than the short side wall 12c. Note that in the present specification, the term “substantially rectangular shape” encompasses, in addition to a perfect rectangular shape (rectangle), for example, a shape whose corner connecting a long side and a short side of the rectangular shape is rounded, a shape whose corner includes a notch, and the like.

As illustrated in FIG. 1, the sealing plate 14 is substantially rectangular in shape in a plan view. As illustrated in FIG. 2, the sealing plate 14 is attached to the exterior body 12 so as to cover the opening 12h of the exterior body 12. The sealing plate 14 faces the bottom wall 12a of the exterior body 12. The battery case 10 is unified in a manner that the sealing plate 14 is joined (for example, joined by welding) to a periphery of the opening 12h of the exterior body 12. The battery case 10 is hermetically sealed (closed).

As illustrated in FIG. 2, the sealing plate 14 is provided with a liquid injection hole 15, a gas discharge valve 17, and two terminal extraction holes 18 and 19. The liquid injection hole 15 is a hole for injecting the nonaqueous electrolyte solution after the sealing plate 14 is assembled to the exterior body 12. The sealing plate 14 is preferably provided with the liquid injection hole 15. The liquid injection hole 15 is sealed by a sealing member 16. The gas discharge valve 17 is configured to break when pressure inside the battery case 10 reaches a predetermined value or more and discharge a gas in the battery case 10 to the outside. The terminal extraction holes 18 and 19 are formed in both end parts of the sealing plate 14 in the long side direction Y (left end part and right end part in FIG. 2, respectively). The terminal extraction holes 18 and 19 penetrate the sealing plate 14 in a thickness direction (up-down direction Z). The terminal extraction holes 18 and 19 respectively have the inner diameters that enable penetration of the positive electrode terminal 30 and the negative electrode terminal 40 before the electrode terminals are attached to the sealing plate 14 (before a caulking process).

Each of the positive electrode terminal 30 and the negative electrode terminal 40 is fixed to the sealing plate 14 of the battery case 10. The positive electrode terminal 30 is disposed on one side of the sealing plate 14 in the long side direction Y (left side in FIG. 1 and FIG. 2). The negative electrode terminal 40 is disposed on the other side of the sealing plate 14 in the long side direction Y (right side in FIG. 1 and FIG. 2). As illustrated in FIG. 2, the positive electrode terminal 30 is inserted to the terminal extraction hole 18 and extends to the outside from the inside of the sealing plate 14, and the negative electrode terminal 40 is inserted to the terminal extraction hole 19 and extends to the outside from the inside of the sealing plate 14. The positive electrode terminal 30 and the negative electrode terminal 40 are preferably attached to the sealing plate 14. The positive electrode terminal 30 and the negative electrode terminal 40 are here caulked to a peripheral part of the sealing plate 14 that surrounds the terminal extraction holes 18 and 19 by the caulking process. Caulking parts 30c and 40c are formed at an end part of the positive electrode terminal 30 and the negative electrode terminal 40 on the exterior body 12 side (lower end part in FIG. 2).

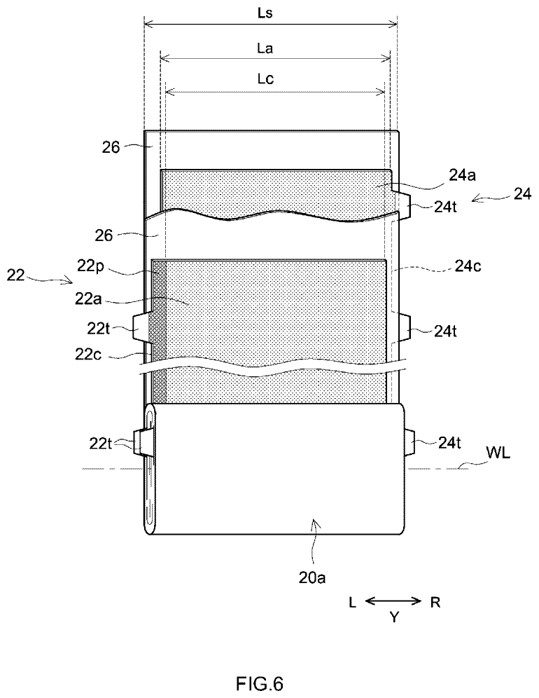

As illustrated in FIG. 2, the positive electrode terminal 30 is electrically connected to a positive electrode 22 (see FIG. 6, in detail, positive electrode tab group 23) of the electrode body group 20 through the positive electrode current collecting part 50 inside the battery case 10. The positive electrode terminal 30 is insulated from the sealing plate 14 by a positive electrode insulating member 70 and a gasket 90. The positive electrode terminal 30 is preferably formed of a metal and is more preferably formed of, for example, aluminum or an aluminum alloy.

The negative electrode terminal 40 is electrically connected to a negative electrode 24 (see FIG. 6, in detail, negative electrode tab group 25) of the electrode body group 20 through the negative electrode current collecting part 60 inside the battery case 10. The negative electrode terminal 40 is insulated from the sealing plate 14 by a negative electrode insulating member 80 and the gasket 90. The negative electrode terminal 40 is preferably formed of a metal and is more preferably formed of, for example, copper or a copper alloy. The negative electrode terminal 40 may be configured of two conductive members joined together and integrated. In the negative electrode terminal 40, for example, a part connected to the negative electrode current collecting part 60 may be formed of copper or a copper alloy, and a part exposed on an outer surface of the sealing plate 14 may be formed of aluminum or an aluminum alloy.

A positive electrode external conductive member 32 and a negative electrode external conductive member 42, each having a plate shape, are attached to the outer surface of the sealing plate 14. The positive electrode external conductive member 32 and the negative electrode external conductive member 42 are members to which a busbar is attached when a plurality of the batteries 100 are electrically connected to each other. The positive electrode external conductive member 32 is electrically connected to the positive electrode terminal 30. The negative electrode external conductive member 42 is electrically connected to the negative electrode terminal 40. The positive electrode external conductive member 32 and the negative electrode external conductive member 42 are insulated from the sealing plate 14 by an external resin member 92. The positive electrode external conductive member 32 and the negative electrode external conductive member 42 are preferably formed of a metal and are more preferably formed of, for example, aluminum or an aluminum alloy. However, the positive electrode external conductive member 32 and the negative electrode external conductive member 42 are not always necessary and can be omitted in another embodiment.

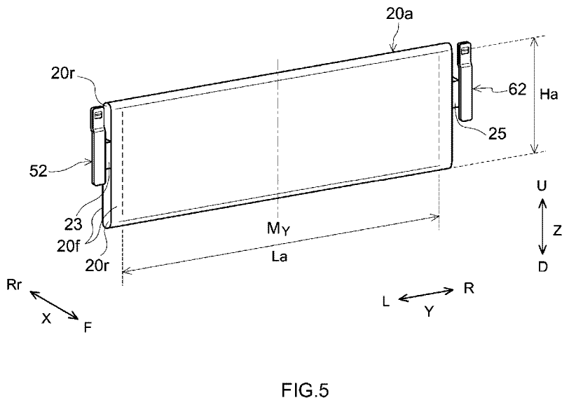

As illustrated in FIG. 2, the electrode body group 20 is accommodated inside the battery case 10 (in detail, inside the exterior body 12). FIG. 4 is a perspective view schematically illustrating the electrode body group 20 attached to the sealing plate 14. The electrode body group 20 here includes three electrode bodies 20a, 20b, and 20c. The number of wound electrode bodies to be disposed in one battery case 10 is, however, not limited in particular and may be two or more (plural), or one. The electrode body group 20 may be disposed inside the battery case 10 in a state of being covered with an electrode body holder with an insulating property. In other words, the electrode body holder may exist between the electrode body group 20 and the battery case 10 (in detail, exterior body 12). The electrode body holder is preferably made of resin.

FIG. 5 is a perspective view schematically illustrating the electrode body 20a. FIG. 6 is a schematic view illustrating a structure of the electrode body 20a. Although detailed description will be given below with the electrode body 20a as an example, the electrode bodies 20b and 20c can also be configured in the similar manner. As illustrated in FIG. 6, the electrode body 20a includes the positive electrode 22 and the negative electrode 24. The positive electrode 22 and the negative electrode 24 are insulated from each other by a separator 26. The electrode body 20a is here a wound electrode body. The electrode body 20a has a structure in which the positive electrode 22 with a band shape and the negative electrode 24 with a band shape are stacked in an insulated state (for example, through the separator 26 with a band shape) and wound using a winding axis WL as a center. In another embodiment, however, the electrode body 20a may be a stack type electrode body in which a plurality of positive electrodes with a square shape and a plurality of negative electrodes with a square shape are stacked on each other in the insulated state.

The electrode body 20a is preferably the wound electrode body. If the electrode body 20a is the wound electrode body, the nonaqueous electrolyte solution is supplied only from both end parts in a winding axis WL direction. Therefore, it becomes particularly difficult for the nonaqueous electrolyte solution to permeate into a central part of the electrode body 20a in the winding axis WL direction and the film in the central part tends to vary in quantity or quality. Thus, it is particularly effective to apply the art disclosed herein.

Although not limited in particular, the number of winding turns (the number of turns) of the electrode body 20a is preferably 20 turns or more, more preferably 30 turns or more, and still more preferably 50 turns or more, and may be 150 turns or less and 100 turns or less, for example.

As illustrated in FIG. 2 and FIG. 6, the electrode body 20a here is disposed inside the battery case 10 in a direction in which the winding axis WL is substantially parallel to the long side direction Y. The winding axis WL direction is a direction that coincides with the long side direction Y (width direction) here. The electrode body 20a is disposed inside the battery case 10 in a direction in which the winding axis WL is parallel to the bottom wall 12a and orthogonal to the short side wall 12c.

The battery 100 here has a so-called lateral tab structure in which the positive electrode tab group 23 and the negative electrode tab group 25 exist on both ends of the electrode body 20a in the winding axis WL direction (left and right in FIG. 2 and FIG. 4). In another embodiment, however, the battery 100 may have a so-called upper tab structure in which the positive electrode tab group 23 and the negative electrode tab group 25 exist on one end of the electrode body 20a in the winding axis WL direction (for example, upper end in FIG. 2 and FIG. 4). In this case, the winding axis WL direction may be a direction that coincides with the up-down direction Z.

As illustrated in FIG. 5, the external shape of the electrode body 20a is a flat shape. The external shape of the electrode body 20a is preferably a flat shape. The electrode body 20a includes a pair of flat parts 20f expanding along the long side direction Y (the winding axis WL direction), and a pair of curved parts (R parts) 20r coupling the pair of flat parts 20f. The flat part 20f includes a flat outer surface (YZ plane in FIG. 5). The curved part 20r includes a curved outer surface. Note that in the present specification, “flat outer surface” is not limited to a perfectly flat surface, and is a term that encompasses a case in which a small step, curve, concave part, convex part, or the like is included when viewed microscopically, for example.

As illustrated in FIG. 2 and FIG. 5, the pair of flat parts 20f face the pair of long side walls 12b of the exterior body 12 in this embodiment. The flat part 20f extends along the long side wall 12b. The pair of curved parts 20r face the bottom wall 12a of the exterior body 12 and the sealing plate 14. The electrode body 20a is preferably disposed inside the battery case 10 in a manner that the stacking direction (thickness direction) of the positive electrode 22 (see FIG. 6) and the negative electrode 24 (see FIG. 6) in the flat part 20f coincides with the short side direction X (direction perpendicular to the long side wall 12b), as described in this embodiment.

The positive electrode 22 may be similar to the conventional positive electrode, without particular limitations. As illustrated in FIG. 6, the positive electrode 22 includes a positive electrode current collector 22c, and a positive electrode active material layer 22a and a positive electrode protection layer 22p that are fixed on at least one surface of the positive electrode current collector 22c. However, the positive electrode protection layer 22p is not essential, and can be omitted in another embodiment. The positive electrode current collector 22c has a band shape here. The positive electrode current collector 22c is formed of, for example, a conductive metal such as aluminum, an aluminum alloy, nickel, or stainless steel. Here, the positive electrode current collector 22c is a metal foil, specifically an aluminum foil.

At one end part (left end part in FIG. 6) of the positive electrode current collector 22c in the long side direction Y (width direction, winding axis WL direction), a plurality of positive electrode tabs 22t are provided. Each of the plurality of positive electrode tabs 22t has a convex shape and protrudes toward one side in the long side direction Y (left side in FIG. 6). The plurality of positive electrode tabs 22t extend in the long side direction Y relative to the separator 26. The positive electrode tabs 22t are provided with a space (intermittently) along a longitudinal direction of the positive electrode 22. By providing the plurality of positive electrode tabs 22t, the resistance of the battery 100 can be reduced. The positive electrode tab 22t constitutes a part of the positive electrode current collector 22c here, and is made of a metal foil (aluminum foil).

As illustrated in FIG. 3, the plurality of positive electrode tabs 22t are stacked at one end part in the long side direction Y (left end part in FIG. 3), and form the positive electrode tab group 23. The plurality of positive electrode tabs 22t are stacked, and bent and curved such that outer ends thereof are aligned. Thus, the accommodating property into the battery case 10 can be improved and the battery 100 can be reduced in size. In addition, the volume energy density of the battery 100 can be improved. A positive electrode second current collecting part 52 of the positive electrode current collecting part 50 to be described below is attached (in detail, joined) to the positive electrode tab group 23. The plurality of positive electrode tabs 22t are connected to the positive electrode second current collecting part 52 in a state of being stacked and bent. The positive electrode tab group 23 is electrically connected to the positive electrode terminal 30 through the positive electrode current collecting part 50.

As illustrated in FIG. 6, the positive electrode active material layer 22a is provided to have a band shape along a longitudinal direction of the positive electrode current collector 22c with a band shape. The positive electrode active material layer 22a contains a positive electrode active material (for example, a lithium transition metal complex oxide such as a lithium nickel cobalt manganese containing complex oxide) capable of reversibly storing and releasing the charge carriers. The positive electrode active material layer 22a may contain any component other than the positive electrode active material, for example, a conductive material, a binder, various additive components, or the like. As the conductive material, for example, a carbon material such as acetylene black (AB) can be used. As the binder, for example, polyvinylidene fluoride (PVdF) or the like can be used.

Although not limited in particular, in the battery 100 of a high-capacity type, which is used for vehicles or the like, as illustrated in FIG. 6, a length Lc (average value, excluding a part formed in the positive electrode tab 22t) of the positive electrode active material layer 22a in the long side direction Y (winding axis WL direction) is preferably 150 mm or more, more preferably 200 mm or more, and still more preferably 250 mm or more. The length Lc is preferably less than or equal to a length La of a negative electrode active material layer 24a in the long side direction Y to be described below.

The positive electrode protection layer 22p is provided between the positive electrode current collector 22c and the positive electrode active material layer 22a in the long side direction Y as illustrated in FIG. 6. Here, the positive electrode protection layer 22p is provided at one end part (left end part in FIG. 6) of the positive electrode current collector 22c in the long side direction Y. The positive electrode protection layer 22p is formed to have a band shape along the positive electrode active material layer 22a. The positive electrode protection layer 22p contains inorganic filler (for example, alumina). The positive electrode protection layer 22p may contain an optional component other than the inorganic filler, such as a conductive material, a binder, or various additive components. The conductive material and the binder may be the same as those described as the examples that may be contained in the positive electrode active material layer 22a.

As illustrated in FIG. 6, the negative electrode 24 includes a negative electrode

current collector 24c and the negative electrode active material layer 24a that is fixed on at least one surface of the negative electrode current collector 24c. The negative electrode current collector 24c has a band shape here. The negative electrode current collector 24c is formed of, for example, a conductive metal such as copper, a copper alloy, nickel, or stainless steel. The negative electrode current collector 24c preferably includes copper or a copper alloy. Here, the negative electrode current collector 24c is a metal foil, specifically a copper foil.

At one end part (right end part in FIG. 6) of the negative electrode current collector 24c in the long side direction Y (width direction, winding axis WL direction), a plurality of negative electrode tabs 24t are provided. Each of the plurality of negative electrode tabs 24t has a convex shape and protrudes toward one side in the long side direction Y (right side in FIG. 6). The plurality of negative electrode tabs 24t extend in the long side direction Y relative to the separator 26. The plurality of negative electrode tabs 24t are provided with a space (intermittently) along a longitudinal direction of the negative electrode 24. By providing the plurality of negative electrode tabs 24t, the resistance of the battery 100 can be reduced. The negative electrode tab 24t here constitutes a part of the negative electrode current collector 24c and is made of a metal foil (copper foil). At least a part of the negative electrode tab 24t is a current collector exposing part in which the negative electrode active material layer 24a is not formed and the negative electrode current collector 24c is exposed.

As illustrated in FIG. 3, the plurality of negative electrode tabs 24t are stacked at one end part in the long side direction Y (right end part in FIG. 3) and form the negative electrode tab group 25. The plurality of negative electrode tabs 24t are stacked, and bent and curved such that outer ends thereof are aligned. Thus, the accommodating property into the battery case 10 can be improved and the battery 100 can be reduced in size. In addition, the volume energy density of the battery 100 can be improved. A negative electrode second current collecting part 62 of the negative electrode current collecting part 60 to be described below is attached (specifically, joined) to the negative electrode tab group 25. The plurality of negative electrode tabs 24t are connected to the negative electrode second current collecting part 62 in a state of being stacked and bent. The negative electrode tab group 25 is electrically connected to the negative electrode terminal 40 through the negative electrode current collecting part 60.

As illustrated in FIG. 6, the negative electrode active material layer 24a is provided to have a band shape along the longitudinal direction of the negative electrode current collector 24c with a band shape. The negative electrode active material layer 24a contains a negative electrode active material (for example, a carbon material such as graphite) capable of reversibly storing and releasing the charge carriers. When a total solid content of the negative electrode active material layer 24a is set to 100 mass %, the negative electrode active material (for example, graphite) may occupy approximately 80 mass % or more, typically 90 mass % or more, and for example 95 mass % or more. The negative electrode active material layer 24a may contain any component other than the negative electrode active material, for example, a binder, a dispersant, various additive components, or the like. As the binder, for example, rubbers such as styrene-butadiene rubber (SBR) can be used. As the dispersant, for example, celluloses such as carboxymethyl cellulose (CMC) can be used.

As illustrated in FIG. 6, the length La (average value, excluding a part formed in the negative electrode tab 24t) of the negative electrode active material layer 24a in the long side direction Y (winding axis WL direction) is typically more than or equal to the length Lc of the positive electrode active material layer 22a in the long side direction Y. Although not limited in particular, the length La of the negative electrode active material layer 24a is preferably 200 mm or more and more preferably 250 mm or more from the viewpoints of increasing the capacity, and the like. In the electrode body 20a, as the length La is longer, the nonaqueous electrolyte solution permeates less easily into the central part including a center M_{Y} (see FIG. 5) in the long side direction Y. As a result, in the central part in the long side direction Y, the film tends to vary in quantity or quality. Thus, it is effective to apply the art disclosed herein. The length La may be, for example, 1000 mm or less and 500 mm or less. Thus, the effect of the art disclosed herein can be achieved at a high level.

As illustrated in FIG. 5, a height Ha of the negative electrode active material layer 24a existing in the flat part 20f of the electrode body 20a (the height Ha is the same as the height of the flat part 20f) is preferably 110 mm or less, more preferably 50 to 110 mm, still more preferably 70 to 100 mm, and particularly preferably 70 to 90 mm. In the flat part 20f, a ratio (horizontal/vertical ratio) of the length La of the negative electrode active material layer 24a in the long side direction Y to the height Ha of the negative electrode active material layer 24a is preferably 1 to 10, more preferably 2 to 7, and still more preferably 3 to 5. Thus, the effect of the art disclosed herein can be achieved at the high level.

The negative electrode active material layer 24a typically includes a film (SEI film) containing a boron (B) element. This boron is a component derived from a compound containing the boron element (B element containing compound) that is added to the nonaqueous electrolyte solution when the battery 100 is constructed, for example, a film formation agent to be described below. The film is, for example, a decomposition product including the B element containing compound that is decomposed at the initial charging. Since the film containing the boron element has excellent stability, the durability and the thermal stability of the battery 100 can be improved suitably.

Incidentally, the present inventors' examination indicates that the resistance tends to become locally high in a root part of the negative electrode active material layer 24a where the negative electrode tab 24t extends (hereinafter also referred to as “a vicinity of the negative electrode tab 24t” simply) because the plurality of negative electrode tabs 24t are bent and curved. Although the limited interpretation is not intended in particular, if the negative electrode tab 24t is bent and curved (in other words, if an external force is applied to the negative electrode tab 24t), for example, the interelectrode distance between the positive electrode 22 and the negative electrode 24 tends to become large locally in the vicinity of the negative electrode tab 24t. As a result, the nonaqueous electrolyte solution tends to gather at that place. If the initial charging is carried out in this state, it is considered that the decomposition of a nonaqueous solvent is promoted, so that the amount of organic film derived from the nonaqueous solvent increases and the resistance tends to become high.

In view of this, in the art disclosed herein, when the root part of the negative electrode active material layer 24a where the negative electrode tab 24t extends (the vicinity of the negative electrode tab 24t) is measured with a spectrometer, the a* value in an L*a*b* color system based on JIS Z8781-4:2013 according to Japan Industrial Standard is 1.3 or less. In the L*a*b* color system, monochrome (brightness) and the coordinate axes of yellow, blue, red, and green (chromaticity) can be separated. The present inventors' examination indicates that a high-resistance part of the negative electrode active material layer 24a appears as “color unevenness”, and therefore can be distinguished based on the a* value (redness) in the L*a*b* color system, which will be described in detail in Example below. When the a* value is adjusted to be a predetermined value or less, the resistance increase in the vicinity of the negative electrode tab 24t can be suppressed. As a result, the battery characteristic can be improved.

The gradation of “the color unevenness” can be distinguished by human eyes, for example; however, since human eyes are different from individual to individual, the result of determining whether there is a color unevenness may vary depending on the individuals. On the other hand, if the objective numerals obtained by the measurement with a spectrophotometer as described in the art disclosed herein are used as an indicator, the accuracy varies less easily relatively. In addition, even the color difference that cannot be determined by the human eyes can be distinguished. Therefore, the resistance can be stably suppressed easily.

Noe that in the present specification, “the root part where the negative electrode tab extends” refers to the range of about 40 mm from the negative electrode tab 24t in the long side direction Y (width direction). The measurement may be performed at a plurality of points in the root part in consideration of the variation. In this case, it is preferable that the a* values at the plurality of points be the predetermined value or less. When the electrode body 20a is the wound electrode body, the measurement is performed at one place or two or more places in the root part of each turn, and it is preferable that all the a* values in the plurality of turns be the predetermine value or less.

The a* value in the root part of the negative electrode tab 24t is preferably 1.2 or less, more preferably 1.1 or less, still more preferably 1.0 or less, and particularly preferably 0.9 or less from the viewpoint of achieving the effect of the art disclosed herein at the high level. The a* value of the negative electrode active material layer 24a is typically 0.1 or more, and may be 0.6 or more or 0.7 or more, for example.

According to the present inventors' examination, the nonaqueous electrolyte solution does not permeate easily in the central part of the negative electrode active material layer 24a in the long side direction Y (width direction). Therefore, the film tends to vary in quantity or quality in the central part of the negative electrode active material layer 24a in the long side direction Y. This may cause the thermal stability to decrease easily.

In view of this, in the art disclosed herein, the amount of carbon element and the amount of boron element are measured by laser ablation inductively coupled plasma mass spectrometry (LA-ICP-MS) along the long side direction Y (width direction) of the negative electrode active material layer 24a, and a value obtained by integrating a ratio (B/C) of the amount of boron element to the amount of carbon element in the range of ±20 mm from the center M_{Y} (see FIG. 5) in the long side direction Y (width direction) is set to 28 or more. The integrated value of the ratio (B/C) indicates that as the value is larger, the amount of boron (B) element is larger in the central part of the negative electrode active material layer 24a in the long side direction Y. According to the present inventors' examination, there is a correlation between the integrated value of the ratio B/C and the amount of heat generation of the battery 100, which will be described in detail in Example below. Specifically, as the integrated value of the ratio B/C is larger, the amount of heat generation of the battery 100 is suppressed. Therefore, by adjusting the aforementioned B/C ratio to be the predetermined value or more, the amount of heat generation can be suppressed and the battery 100 with the excellent thermal stability can be provided.

From the viewpoint of achieving the effect of the art disclosed herein at the high level, the integrated value of the ratio (B/C) is preferably 30 or more, more preferably 35 or more, still more preferably 40 or more, and particularly preferably 50 or more. From the viewpoints of suppressing the resistance and the like, the integrated value of the ratio (B/C) is preferably 100 or less and more preferably 80 or less.

Note that the a* value and/or the integrated value of the ratio (B/C) described above can be adjusted suitably by not just the amount of injecting the nonaqueous electrolyte solution or the concentration of the additive (the compound containing the boron element) in the nonaqueous electrolyte solution when the battery 100 is constructed but also, for example, conditions in an electrolyte solution impregnating step (step 2), particularly conditions in a pressurization or depressurization impregnating step (step 2-1) or conditions in an initial charging step (step 3), for example a pressing force (restriction load) or the like in a manufacturing method to be described below.

As illustrated in FIG. 6, the separator 26 is a member that insulates the positive electrode active material layer 22a of the positive electrode 22 and the negative electrode active material layer 24a of the negative electrode 24 from each other. A length Ls of the separator 26 in the long side direction Y (winding axis WL direction) is typically more than or equal to the length La of the negative electrode active material layer 24a in the long side direction Y. The separator 26 is preferably, for example, a porous sheet made of resin including polyolefin resin such as polyethylene (PE) or polypropylene (PP). The separator 26 may include a functional layer such as an adhesive layer or a heat resistance layer (HRL) on a surface of a base material part formed by a porous sheet made of resin. The adhesive layer is a layer including a binder. For example, the heat resistance layer is a layer including inorganic filler such as alumina, silica, boehmite, magnesia, or titania and a binder such as PVdF. The heat resistance layer can also serve as the adhesive layer. The structures of the heat resistance layer and the adhesive layer may be similar to the conventional structures thereof.

As illustrated in FIG. 2, the positive electrode current collecting part 50 forms a conductive path for electrically connecting the positive electrode terminal 30 and the positive electrode tab group 23 formed by the plurality of positive electrode tabs 22t. The positive electrode current collecting part 50 may be formed of the same metal species as the positive electrode current collector 22c, for example, a conductive metal such as aluminum, an aluminum alloy, nickel, or stainless steel. The positive electrode current collecting part 50 includes a positive electrode first current collecting part 51 that is connected to the positive electrode terminal 30 and the positive electrode second current collecting part 52 that is connected to the positive electrode tab group 23. The positive electrode first current collecting part 51 is attached to an inner surface of the sealing plate 14.

The positive electrode second current collecting part 52 extends along the short side wall 12c of the exterior body 12. The positive electrode second current collecting part 52 is attached to the positive electrode tab group 23 of the electrode body 20a. As illustrated in FIG. 3, a joining part J with the positive electrode tab group 23 is formed in the positive electrode second current collecting part 52. The joining part J is a welding joining part formed by welding, such as ultrasonic welding, resistance welding, or laser welding, with the plurality of positive electrode tabs 22t stacked on each other, for example. The joining part J is disposed with the plurality of positive electrode tabs 22t placed on one side of the electrode bodies 20a, 20b, and 20c in the short side direction X (front side in FIG. 3). Thus, the plurality of positive electrode tabs 22t can be bent suitably in the stacked state and the positive electrode tab group 23 with the curved shape can be formed stably.

As illustrated in FIG. 2, the negative electrode current collecting part 60 forms a conductive path for electrically connecting the negative electrode terminal 40 and the negative electrode tab group 25 formed by the plurality of negative electrode tabs 24t. The negative electrode current collecting part 60 may be formed of the same metal species as the negative electrode current collector 24c, for example, a conductive metal such as copper, a copper alloy, nickel, or stainless steel. The negative electrode current collecting part 60 includes a negative electrode first current collecting part 61 that is connected to the negative electrode terminal 40 and the negative electrode second current collecting part 62 that is connected to the negative electrode tab group 25. The structure and arrangement of the negative electrode first current collecting part 61 and the negative electrode second current collecting part 62 may be similar to those of the positive electrode first current collecting part 51 and the positive electrode second current collecting part 52 of the positive electrode current collecting part 50, respectively.

The negative electrode second current collecting part 62 is attached to the negative electrode tab group 25 of the electrode body 20a. As illustrated in FIG. 3, the joining part J with the negative electrode tab group 25 is formed in the negative electrode second current collecting part 62. The joining part J is a welding joining part formed by welding, such as ultrasonic welding, resistance welding, or laser welding, with the plurality of negative electrode tabs 24t stacked on each other, for example, similarly to that on the positive electrode side. The joining part J is disposed with the plurality of negative electrode tabs 24t placed on one side of the electrode bodies 20a, 20b, and 20c in the short side direction X (front side in FIG. 3). Thus, the plurality of negative electrode tabs 24t can be bent suitably in the stacked state and the negative electrode tab group 25 with the curved shape can be formed stably.

The nonaqueous electrolyte solution typically contains a nonaqueous solvent and an electrolyte salt (supporting salt). As the nonaqueous solvent, one kind or two or more kinds of nonaqueous solvents that have conventionally been known as being usable for the nonaqueous electrolyte solution secondary battery can be used. Examples of the nonaqueous solvent include organic solvents such as carbonates, ethers, esters, nitriles, sulfones, and lactones. The nonaqueous solvent preferably includes the carbonates. Examples of the carbonates include chain carbonates such as ethylene carbonate (EC), dimethyl carbonate (DMC), diethyl carbonate (DEC), and ethyl methyl carbonate (EMC) and cyclic carbonates such as propylene carbonate (PC).

The electrolyte salt is not limited to a particular type as long as the charge carriers (typically, lithium ion) are included, and one kind or two or more kinds of electrolyte salts that have conventionally been known as being usable for the nonaqueous electrolyte solution secondary battery can be used. One example of the electrolyte salt is fluorine-containing lithium salt such as LiPF₆ or LiBF₄. The electrolyte salt preferably contains LiPF₆.

The nonaqueous electrolyte solution may further contain an additional component (additive). As the additive, one kind or two or more kinds of additives that have conventionally been known as being able to be added to the nonaqueous electrolyte solution can be used. Examples of the additive include: a boron-based additive containing a boron element, such as lithium bisoxalate borate (LiBOB) or lithium difluoro (oxalato) borate (LiODFB); a phosphorus-based additive containing a phosphorus element, such as lithium difluorophosphate (LiPO₂F₂) or lithium difluorooxalate phosphate (LiDFOP); and the like. These additives may be so-called film formation agents that are decomposed before (at lower potential than) the nonaqueous solvent and/or the electrolyte salt at the initial charging and deposited as the film on the surface of the negative electrode active material layer 24a.

The nonaqueous electrolyte solution preferably includes the compound containing the boron (B) element (B element containing compound), for example a lithium salt containing the boron element (B element containing lithium salt). Examples of the B element containing compound (for example, B element containing lithium salt) include LiBF₄ given above as the example of the supporting salt, and an oxalato complex compound containing the boron element (B element containing oxalato compound) such as LiBOB or LiODFB given above as the example of the boron-based additive.

The additive that is added into the nonaqueous electrolyte solution at the manufacture (for example, the boron-based additive described above) is decomposed electrically by the initial charging or the like and consumed to form the film on the negative electrode active material layer 24a or the like. Therefore, in the state of the battery 100, the additive as described above may be included (remain) or may not be included in the nonaqueous electrolyte solution.

### Manufacturing Method for Battery 100

For example, the battery 100 can be manufactured by a manufacturing method including the following steps in the following order: a constructing step for a battery assembly (step 1), the electrolyte solution impregnating step (step 2), the initial charging step (step 3), a defoaming step (step 4), a liquid injection hole sealing step (step 5), and an aging step (step 6). However, the defoaming step (step 4) is optional and can be omitted in another embodiment. Additionally, another step may be included at an optional stage. For example, the aging step (step 6) may be followed by an activating step.

In the constructing step (step 1), the electrode body group 20 (the electrode bodies 20a, 20b, and 20c) and the nonaqueous electrolyte solution are accommodated in the battery case 10 to construct a battery assembly typically in a glove box. In this specification, the term “battery assembly” refers to an intermediate object assembled up to the state before the initial charging step (step 3) is performed in the manufacturing process for the battery 100. The order of accommodating the electrode body group 20 and the nonaqueous electrolyte solution in the battery case 10 is not limited in particular. It is preferable that the nonaqueous electrolyte solution be injected into the battery case 10 after the electrode body group 20 is accommodated in the battery case 10.

In a preferred embodiment, the present step includes a disposing step (step 1-1), a welding joining step (step 1-2), a drying step (step 1-3), and a liquid injecting step (step 1-4) typically in this order. However, the drying step (step 1-3) is optional and can be omitted in another embodiment. In still another embodiment, the order of the welding joining step (step 1-2) and the drying step (step 1-3) may be opposite. Additionally, another step may be included at an optional stage.

In the disposing step (step 1-1), the electrode body group 20 is disposed inside the exterior body 12. Specifically, the electrode body group 20 is accommodated inside the exterior body 12 through the opening 12h. Next, in the welding joining step (step 1-2), the sealing plate 14 is welded at the periphery of the opening 12h of the exterior body 12 to integrate the exterior body 12 and the sealing plate 14. Then, in the drying step (step 1-3), the exterior body 12 accommodating the electrode body group 20 is dried with the liquid injection hole 15 opened, so that the moisture inside the exterior body 12 is removed. In particular, the moisture inside the electrode body group 20 is removed. The moisture is removed similarly to the conventional art using a heating and drying device, a vacuum drying device, or the like through operations of heating, decompression, and the like carried out alone or in combination. The heating temperature is preferably set so that the moisture can be evaporated suitably in a decompressed state and the separator of the electrode body group 20 and the like do not thermally deteriorate, for example. The heating temperature can be set in the range of, for example, 50 to 200° C.

Next, in the liquid injecting step (step 1-4), first, the nonaqueous electrolyte solution is prepared. The nonaqueous electrolyte solution preferably includes the B element containing compound (for example, B element containing lithium salt) as described above. In one example, the nonaqueous electrolyte solution preferably includes the boron-based additive in addition to the nonaqueous solvent and the electrolyte salt. Although not limited in particular, the concentration of the boron-based additive in the nonaqueous electrolyte solution is preferably 0.01 mol/L or more and more preferably 0.05 mol/L or more because the film in suitable quantity and quality is easily formed on the surface of the negative electrode active material layer 24a. On the other hand, from the viewpoint of suppressing the increase in battery resistance, the concentration of the boron-based additive in the nonaqueous electrolyte solution is preferably 1 mol/L or less, more preferably 0.5 mol/L or less, and still more preferably 0.1 mol/L or less. The prepared nonaqueous electrolyte solution is injected into the battery case 10 through the liquid injection hole 15 of the sealing plate 14. The liquid is injected preferably with the inside of the battery case 10 decompressed in order to improve the impregnation of the electrode body group 20 (the electrode bodies 20a, 20b, and 20c) with the nonaqueous electrolyte solution.

In the electrolyte solution impregnating step (step 2), after the constructing step for the battery assembly (specifically, the liquid injecting step), the impregnation of the electrode body group 20, particularly the central part thereof in the long side direction Y with the nonaqueous electrolyte solution is increased. This step may be performed in a normal temperature (about 25° C.±10° C.) environment. In a preferred embodiment, this step includes the pressurization or depressurization impregnating step (step 2-1) and a second impregnating step (step 2-2) in this order. Another step may further be included at an optional stage. The necessary time for this step (the total time of the pressurization or depressurization impregnating step and the second impregnating step) is preferably 10 to 200 hours. Accordingly, the film in the suitable quantity and quality can be formed easily on the surface of the negative electrode active material layer 24a and the effect of the art disclosed herein can be exerted at the high level.

In the pressurization or depressurization impregnating step (step 2-1), the inside of the battery assembly is pressurized or depressurized. In one example, first, the battery assembly is accommodated in a chamber in which the pressure can be regulated, while the liquid injection hole 15 is opened (in other words, in a state where there is no difference in pressure inside and outside the battery case 10). Then, (1) a pressurizing operation of pressurizing the inside of the chamber and keeping the pressurized state for a predetermined time, and (2) a depressurizing operation of depressurizing the inside of the chamber and keeping the depressurized state for a predetermined time are performed. The order of the pressurizing operation and the depressurizing operation is not limited in particular but, in one example, it is preferable to perform the depressurizing operation after the pressurizing operation.

The conditions of the pressurizing and the depressurizing, for example the pressure and the keeping time, are preferably adjusted as appropriate in accordance with the length Lc of the negative electrode active material layer 24a in the long side direction Y, and the like. In one example, in a case where the length Lc of the negative electrode active material layer 24a in the long side direction Y is 200 mm or more, the pressure to be applied in this step (pressurizing degree) is preferably 0.60 MPa or more and more preferably 0.80 MPa or more. The keeping time in the pressurized state is preferably 30 minutes or more (for example, 30 to 120 minutes) and more preferably 40 minutes or more.

According to the present inventors' examination, there is a positive correlation between the keeping time in the pressurized state in this step and the integrated value of the aforementioned ratio (B/C) in the central part of the negative electrode active material layer 24a. That is to say, as the keeping time in the pressurized state is longer, the integrated value of the aforementioned ratio (B/C) in the central part of the negative electrode active material layer 24a tends to become larger. In other words, the amount of boron (B) element tends to become larger in the central part in the long side direction Y. Therefore, by setting the keeping time in the pressurized state to be a predetermined value or more, the integrated value of the ratio (B/C) can be adjusted easily to be in the aforementioned range (for example, 28 or more).

In addition, the pressure to be reduced in this step (depressurizing degree) is preferably −0.070 to −0.098 MPa (−70 to −100 kPa) and more preferably −0.080 to −0.090 MPa (−80 to −90 kPa). The keeping time in the depressurized state is preferably shorter than the keeping time in the pressurized state. The keeping time in the depressurized state is preferably 1 to 10 minutes and for example, 5 minutes or more.

In this step, each of the pressurizing operation and the depressurizing operation is preferably performed once. The present inventors' examination indicates that as the pressurizing operation and the depressurizing operation are repeated more, the interelectrode distance between the positive electrode 22 and the negative electrode 24 increases in the vicinity of the negative electrode tab 24t and as a result, the resistance tends to become high. By performing each of the pressurizing operation and the depressurizing operation once, the increase in interelectrode distance between the positive electrode 22 and the negative electrode 24 can be suppressed and the increase in resistance can be suppressed. Thus, the a* value in the vicinity of the negative electrode tab 24t can be adjusted easily to be in the aforementioned range (for example, 1.3 or less).

Next, in the second impregnating step (step 2-2), the battery assembly is left (kept) in the atmospheric pressure state. Thus, the impregnation of the inside of each of the electrode bodies 20a, 20b, and 20c, particularly the central part in the long side direction Y with the nonaqueous electrolyte solution can be promoted further.

In the initial charging step (step 3), the battery assembly is charged at least once after the electrolyte solution impregnating step. By the initial charging, the additive in the nonaqueous electrolyte solution (for example, boron-based additive) is electrically decomposed before the other components (nonaqueous solvent and electrolyte salt) in the nonaqueous electrolyte solution typically. Thus, the film (SEI film) is formed on the surface of the negative electrode active material layer 24a. For example, in the case where the B element containing compound (typically, B element containing lithium salt) is included in the nonaqueous electrolyte solution, the film (SEI film) including the decomposition product of the B element containing compound is formed on the surface of the negative electrode active material layer 24a.

The initial charging is preferably performed in a state where a predetermined region of the battery case 10 is pressed. Specifically, the initial charging is performed preferably while a part where the positive electrode active material layer 22a and the negative electrode active material layer 24a of the flat part 20f face each other is pressed. In particular, it is preferable that the initial charging be performed while vicinities of the positive electrode tab 22t and the negative electrode tab 24t (in other words, a place where the interelectrode distance between the positive electrode 22 and the negative electrode 24 is long so that the nonaqueous electrolyte solution tends to remain) are pressed. Thus, the local increase in interelectrode distance in the vicinities of the positive electrode tab 22t and the negative electrode tab 24t can be suppressed and for example, the a* value in the root part of the negative electrode tab 24t can be easily adjusted to be in the range described above (for example, 1.3 or less).

In a preferred embodiment, first, a cell pressing machine including a pair of restriction plates is prepared. Moreover, a pressing member for pressing a predetermined region of the battery case 10 is prepared. The pressing member is preferably smaller than the long side wall 12b of the battery case 10, and also preferably smaller than the electrode body 20a inside the battery case 10. It is preferable that the pressing member do not press largely the positive electrode tab group 23 and the negative electrode tab group 25 in the long side direction Y and have the length that can press the range from the root part of the positive electrode tab group 23 to the root part of the negative electrode tab group 25. It is preferable that the length of the pressing member be more than or equal to the length of the part where the positive electrode active material layer 22a and the negative electrode active material layer 24a face each other (here, the length Lc of the positive electrode active material layer 22a) in the long side direction Y. Thus, the local increase in interelectrode distance can be suppressed at the high level. The length of the pressing member is preferably more than the length La of the negative electrode active material layer 24a. The pressing member preferably has the length that can press substantially the entire negative electrode active material layer 24a in the long side direction Y. The length of the pressing member is preferably 150 mm or more, more preferably 200 mm or more, and still more preferably 250 mm or more.

In this embodiment, the height of the pressing member is smaller than the total height of the electrode body 20a and additionally smaller than the height Ha of the negative electrode active material layer 24a (the height of the flat part 20f) in the up-down direction Z. Thus, the initial charging can be performed in a state where the flow channel of the nonaqueous electrolyte solution is secured and the electrode body group 20 (electrode bodies 20a, 20b, and 20c) is impregnated sufficiently with the nonaqueous electrolyte solution. The height of the pressing member is preferably 100 mm or less, more preferably 50 to 100 mm, still more preferably 60 to 90 mm, and particularly preferably 70 to 80 mm.

In the present step, next, the pair of long side walls 12b of the battery assembly are held between two pressing members from the short side direction X. Specifically, the battery assembly and the pressing member are disposed to face each other so that a center of the long side wall 12b of the battery case 10 coincides with a center of the pressing member. In this state, the battery assembly is disposed between the pair of restriction plates of the pressing machine and charging is performed with a predetermined pressing force (restriction load) applied to the battery assembly. From the viewpoint of achieving the effect of the art disclosed herein at the high level, the restriction load is preferably 10 kN or more, and more preferably 15 kN or more (for example, 17 kN).

In the state where the battery case 10 is pressed in this manner, the battery assembly is charged. The battery assembly can be charged similarly to the conventional charging. Typically, an external power source is connected between the positive electrode terminal and the negative electrode terminal of the battery assembly, and charging is performed until the voltage between the positive and negative electrode terminals becomes a predetermined attainment voltage. In the case where the nonaqueous electrolyte solution includes the additive, charging is preferably performed until at least the decomposing potential of the additive. The attainment voltage may be set to generally 3 V or more, typically 3.5 V or more, and for example 4 V or more in the case where, for example, the negative electrode active material is a carbon material such as graphite. The charging rate may be, for example, about 0.1 C to 2 C. For example, the charging may be performed once, or twice or more with the discharging conducted between the charging processes. Note that the present step may be performed in the normal temperature (for example, about 25° C.±10° C., 25° C.±5° C.) environment, or in a high temperature environment of about 45° C., for example. By charging in the high temperature environment, the film formation can be promoted.

In the defoaming step (step 4), after the initial charging step, the gas in the battery case 10, for example air, gas generated by the decomposition of the nonaqueous electrolyte solution in the initial charging step, and the like are discharged to the outside of the battery case 10. The gas can be discharged by, for example, decompressing the inside of the battery case 10. Then, in the liquid injection hole sealing step (step 5), the liquid injection hole 15 is sealed with the sealing member 16 preferably with the inside of the battery case 10 kept at the normal pressure or decompressed. Thus, the battery case 10 is hermetically sealed (closed).

In the aging step (step 6), the battery assembly after the initial charging is restricted and kept for a predetermined aging period with a predetermined restriction load applied from the short side direction X (thickness direction of the electrode body group 20) under a predetermined temperature environment. The temperature environment is preferably 15 to 40° C. and may be normal temperature (about 25° C.±10° C.), for example. The restriction load may be 1 to 6 kN. In a preferred embodiment, first, a cell pressing machine including a pair of restriction plates is prepared. Next, the battery assembly after the initial charging is disposed between the pair of restriction plates so that the pair of long side walls 12b of the battery case 10 face the restriction plates, and in this state, the restriction load is applied to the battery assembly after the initial charging using the pressing machine and the battery assembly is kept for the predetermined aging period. The aging period can vary depending on, for example, the length La of the negative electrode active material layer 24a in the long side direction Y, the conditions in the electrolyte solution impregnating step (step 2), and the like, and is preferably about five days or more and more preferably six days or more. In this step, the voltage adjusted in the initial charging step may be kept. The battery 100 can be manufactured suitably as above.

### Inspection Method for Negative Electrode 24

For example, the battery assembly after the initial charging or the battery 100 after the steps up to the aging step (step 6) is subjected to a sampling inspection as quality management regarding the variation in resistance and the thermal stability. In the sampling inspection, the negative electrode 24 can be treated as the object to be inspected. Thus, in the inspection method disclosed herein, the battery assembly (or battery 100) after at least the constructing step (step 1), the electrolyte solution impregnating step (step 2), and the initial charging step (step 3) in the manufacturing method described above is subjected to the following steps in this order: a disassembling step (step 7) of disassembling the battery assembly or the battery 100 and a measuring step (step 8). In this embodiment, the measuring step (step 8) is followed by an evaluating step (step 9) of evaluating the resistance or the thermal stability of the battery assembly or the battery 100. In addition, another step may be included at an optional stage.

In the disassembling step (step 7), the battery assembly is disassembled. The battery assembly is disassembled preferably in a dry air (for example, with a dew point of about −50° C.) atmosphere, for example in a glove box, in order to avoid the change in quality of the negative electrode 24 or the separator 26. The battery assembly can be disassembled for example in such a way that, first, the battery case 10 is cut with a tool such as an end mill, a laser, or the like, the sealing plate 14 is separated from the exterior body 12, and the electrode body group 20 is extracted from the inside of the exterior body 12. Then, the electrode body 20a is separated from the extracted electrode body group 20 and the winding is unfastened; thus, the positive electrode 22, the negative electrode 24, and the separator 26 can be separated from each other.

The measuring step (step 8) includes a first measuring step (step 8a) of measuring the a* value and a second measuring step (step 8b) of measuring the B/C ratio and calculating the integrated value. In the first measuring step (step 8a), the a* value is measured using the spectrometer in the vicinity of the negative electrode tab 24t of the negative electrode active material layer 24a (the root part where the negative electrode tab 24t extends) after the disassembling step. The measurement may be performed a plurality of times in consideration of the variation. In this case, the arithmetic average of the plurality of measurement values can be employed as the a* value. As described above, there is a positive correlation between the a* value and the resistance value. Thus, measuring the a* value makes it possible to easily distinguish the high-resistance part. In the second measuring step (step 8b), the B/C ratio is measured to calculate the integrated value in the central part of the negative electrode active material layer 24a in the long side direction Y using LA-ICP-MS after the disassembling step. As described above, there is a negative correlation between the integrated value of the B/C ratio and the amount of heat generation of the battery 100. Therefore, by measuring the B/C ratio and calculating the integrated value, the thermal stability (heat generation behavior) of the battery 100 can be predicted and confirmed easily.

In the evaluating step (step 9), the resistance and the thermal stability are evaluated about the battery assembly or the battery 100. In a preferred embodiment, the good product determination is performed based on the a* value and the integrated value of the B/C ratio. For example, the product is determined to be good when the a* value is the predetermined value or less (for example, 1.3 or less) and the integrated value of the B/C ratio is the predetermine value or more (for example, 28 or more). In this case, the battery assembly or the battery 100 that is determined to be the good product can have the low resistance and the excellent thermal stability and vary less in quality. Thus, the battery 100 with the high reliability can be supplied suitably to the market.

### Application of Battery 100

The battery 100 is usable in various applications, and can be suitably used as a motive power source for a motor (power source for driving) that is mounted in a vehicle such as a passenger car or a truck because of having the high capacity, the low resistance, and the excellent thermal stability, for example. The vehicle is not limited to a particular type, and may be, for example, a plug-in hybrid electric vehicle (PHEV), a hybrid electric vehicle (HEV), or a battery electric vehicle (BEV). The battery 100 can also be suitably used as a battery pack in which the plurality of batteries 100 are arranged in a predetermined arrangement direction and a load is applied from the arrangement direction by a restriction mechanism.

Several Examples relating to the present disclosure will be explained below, but the present disclosure is not meant to be limited to these Examples.

### Manufacture of Battery for Evaluation

In the constructing step (step 1), battery assemblies with the same structure (Example, and Comparative Examples 1 and 2) were constructed. Specifically, first, a lithium nickel cobalt manganese complex oxide (LiNi_{0.6}Co_{0.2}Mn_{0.2}O₂, NCM) was prepared as the positive electrode active material. Then, a positive electrode sheet with a band shape including, on an aluminum foil as the positive electrode current collector, the positive electrode active material layer including this positive electrode active material, a carbon material (AB) as the conductive material, and PVdF as the binder in a mass ratio of NCM:AB:PVdF=97.5:1.5:1.0 was manufactured. In addition, a negative electrode sheet with a band shape including, on a copper foil as the negative electrode current collector, the negative electrode active material layer including graphite (C) as the negative electrode active material, and SBR and CMC as the binder in a mass ratio of C:(SBR+CMC)=98.5:1.5 was manufactured.

Next, the positive electrode sheet and the negative electrode sheet that were manufactured as above were disposed to face each other through a separator sheet and wound in a flat shape; thus, the wound electrode body was manufactured. Note that as the separator sheet, a separator sheet including a heat resistance layer (also functioning as an adhesive layer) including alumina and PVdF on a surface of a base material part made of PE was used. In addition, the length La of the negative electrode active material layer in the long side direction (winding axis direction) was 290 mm and the height Ha was 90 mm.

Next, the nonaqueous electrolyte solution was prepared in a manner that LiPF₆ was dissolved in a mixed solvent in which EC, EMC, and DMC were mixed, and LiBOB was added thereto as the additive so as to have a concentration of 0.05 mol/L. Then, the wound electrode body and the nonaqueous electrolyte solution manufactured as above were accommodated in the battery case with a cuboid shape and thus, the battery assembly was constructed.

In the electrolyte solution impregnating step (step 2) in each example, first, the battery assembly was accommodated in the chamber in which the pressure can be regulated while the liquid injection hole was kept open. In Example, as shown in Table 1, the pressurizing operation of applying pressure in the battery case up to 0.8 MPa and keeping that state for 50 minutes was performed, and then the depressurizing operation of reducing the pressure to −90 kPa and keeping that state for 5 minutes was performed. Subsequently, the pressure in the battery case was returned to 0 MPa (pressurization or depressurization impregnating step (step 2-1)). In contrast to this, only the depressurizing operation was performed under the conditions shown in Table 1 in Comparative Example 1, and only the pressurizing operation was performed under the conditions shown in Table 1 in Comparative Example 2. In Comparative Example 2, an operation of applying pressure in the battery case up to 0.8 MPa, keeping this state for 6 minutes, and then returning the pressure in the battery case to 0 MPa was repeated 20 times. After that, in each example, the battery assembly was left (second impregnating step (step 2-2)). Table 1 shows the ratio (relative value) of the total required time in the electrolyte solution impregnating step (step 2).

In the initial charging step (step 3), first, the pressing member was prepared. Next, the pressing member was disposed based on the center of the long side wall of the constructed battery assembly, and the battery assembly and the pressing member were restricted with the restriction load shown in Table 1. Thus, a part of the flat part of the wound electrode body where the positive electrode active material layer and the negative electrode active material layer faced each other was restricted by the pressing member. In the long side direction, the flat part of the wound electrode body was pressed by the pressing member in the range from the root part of the positive electrode tab group to the root part of the negative electrode tab group. Next, the battery assembly with the restriction load applied thereto was charged at a charging rate of 0.2 C to a state of charge (SOC) of 12%. Next, in the defoaming step (step 4), the pressure in the battery case was reduced to −0.09 MPa. Subsequently, in the liquid injection hole sealing step (step 5), the liquid injection hole was sealed with the sealing member with the pressure in the battery case 10 reduced. Next, in the aging step (step 6), the battery assembly after the initial charging was kept for five days with a restriction load of 4 kN applied to the battery assembly in the temperature environment of 25° C. Then, the activating process was performed and sampling was performed at a place indicated by an arrow. In this manner, the batteries for evaluation (Example, and Comparative Examples 1 and 2) were manufactured.

TABLE 1

| | | | Comparative | Comparative | |
|---|---|---|---|---|---|
| | | | Example 1 | Example 2 | Example |
| Manufacturing | Electrolyte solution impregnating step | | Depressurization | Pressurization | Pressurization or |
| method | | | impregnation | impregnation | depressurization |
| | | | | | impregnation |
| | Pressurization | Pressure | — | 0.8 | 0.8 |
| | | | | MPa | MPa |
| | | Keeping time | — | 6 | 50 |
| | | | | minutes | minutes |
| | Pressurization frequency | | — | 20 | Once |
| | | | | times | |
| | Depressurization | Pressure | −90 | — | −90 |
| | | | kPa | | kPa |
| | | Keeping time | 10 | — | 5 |
| | | | minutes | | minutes |

| | Depressurization frequency | Once | — | | | Once |
|---|---|---|---|---|---|---|
| | Ratio of total impregnation time in impregnating | 1 | 0.4 | | | 0.4 |
| | step (relative value) | | | | | |
| | Restriction load in initial charging step | 8 | 8 | | | 17 |
| | | kN | KN | | | kN |
| Evaluation | Recognition of color unevenness | Not | Recognized | Recognized | Recognized | Not |
| result | with human eyes | recognized | (Large) | (Small) | (Large) | recognized |
| | (Degree of color unevenness) | — | | | | — |
| | Measurement place of end part | FIG. | FIG. | FIG. | FIG. | FIG. |
| | of negative electrode | 7A (1) | 7B (1) | 7B (2) | 7B (3) | 7C (1) |
| | Resistance (Ω) | 250 | 600 | 520 | 580 | 380 |
| | Resistance ratio (relative value) | 1.0 | 2.4 | 2.08 | 2.32 | 1.52 |
| | a* value in L*a*b* color system | 0.83 | 3.60 | 1.36 | 2.10 | 0.85 |

| | | | |
|---|---|---|---|
| Integrated value of ratio (B/C) | 24 | 30 | 52 |
| Heat generation amount of battery (J) | 26.3 | 17.4 | 16.6 |

### Disassembling of Battery for Evaluation

In the disassembling step (step 7), the battery for evaluation after the activating step was discharged until the voltage became 3.0 V and disassembled in a dry air atmosphere (for example, with a dew point of about −50° C.), and then, the wound electrode body was extracted from the battery case. After that, the winding of the wound electrode body was unfastened to separate the negative electrode.

### Checking of Color Unevenness of Negative Electrode and Resistance Measurement

First, the negative electrode was cut out into the suitable size along the long side direction and cleaned with DMC; thus, a test body for resistance measurement was obtained. Note that the cutting position was the flat part existing at the 15th turn (intermediate periphery) from a winding start end part. Next, the color unevenness in the negative electrode active material layer (particularly in the vicinity of the negative electrode tab) was observed with human eyes. The results are shown in Table 1. As shown in Table 1, the color unevenness in the negative electrode active material layer was not recognized in Comparative Example 1 in which only the depressurizing operation was performed in the electrolyte solution impregnating step and in Example in which each of the pressurizing operation and the depressurizing operation was performed once in the electrolyte solution impregnating step. On the other hand, in Comparative Example 2 in which the pressurizing operation was repeated in the electrolyte solution impregnating step, a part with the large color unevenness and a part with the small color unevenness were recognized with human eyes. The reason is considered as follows: by repeating the pressurizing in the electrolyte solution impregnating step, the positive and negative electrodes are separated from each other more and the nonaqueous electrolyte solution remains locally, so that a large amount of organic film derived from the nonaqueous solvent is generated at the initial charging.

Next, a resistance inspection device including a placement part that accommodates the test body and the nonaqueous electrolyte solution, a probe to be brought into contact with a measurement point, and an AC impedance measurement part was prepared. Regarding a device structure of the resistance inspection device, for example, Japanese Patent Application Publication No. 2014-25850 can be referred to. The probe includes a tubular main body part that accommodates the nonaqueous electrolyte solution and a counter electrode (metal Li) and a measurement part continuing from a lower end of the main body part to be in contact with a part (measurement point) of the negative electrode active material layer of the test body, for example, and is configured to be able to move along a long side direction (width direction) of the test body. The measurement part has a diameter of about Φ1 mm to 10 mm, for example. The AC impedance measurement part is configured to measure the impedance by inputting AC or AC voltage between a working electrode in contact with the negative electrode tab and the measurement point (counter electrode) in contact with the measurement point of the probe.

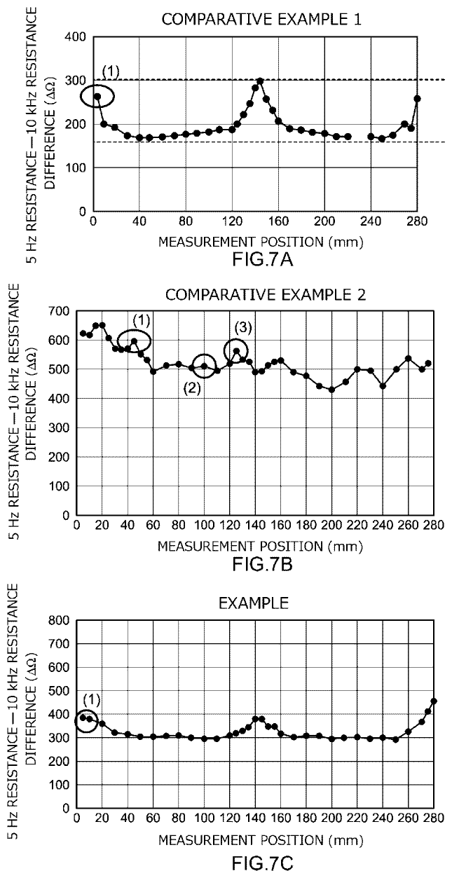

Next, the placement part of the resistance inspection device was filled with the nonaqueous electrolyte solution (only the nonaqueous solvent and the supporting salt were used, and the additive was not added), and the test body was disposed in the placement part. Then, with the working electrode in contact with the negative electrode tab, the probe was moved at a measurement interval of about 10 mm along the long side direction (width direction) from the root part of the negative electrode active material layer where the negative electrode tab extends and the resistance on the surface of the negative electrode active material layer was measured in spots in accordance with the AC impedance method. Specifically, a difference in resistance (ΔΩ) from DC to an impedance arc terminal was acquired for each measurement point. Then, the resistance distribution expressing a relation between the measurement point and the difference in resistance (ΔΩ) was created. The resistance distribution in Comparative Example 1 is shown in FIG. 7A, the resistance distribution in Comparative Example 2 is shown in FIG. 7B, and the resistance distribution in Example is shown in FIG. 7C.

Regarding Comparative Example 1 and Example, the resistance values in the vicinity of the negative electrode tab of the negative electrode active material layer (part (1) in FIG. 7A and FIG. 7C) are shown in Table 1. Regarding Comparative Example 2, the resistance values of parts with color unevenness in the vicinity of the negative electrode tab of the negative electrode active material layer (parts (1) to (3) in FIG. 7B) are shown in Table 1. As shown in Table 1, it is understood that the resistance value was relatively high in the part where the color unevenness was recognized with human eyes. Note that Table 1 also shows a resistance ratio when the resistance in the vicinity of the negative electrode tab of the negative electrode active material layer (end part of the negative electrode active material layer) in Comparative Example 1 is the reference (1.0). This indicates that the resistance ratio was twice or less in Example while the resistance ratios were more than twice in Comparative Example 2.

### Measurement by Spectrometer

In the first measuring step (step 8a), a spectrometer of a diffusion illumination type manufactured by KONICA MINOLTA, INC. (model type: CM-26dG) and a specular component include (SCI) method of taking in specular reflation light with a trap of the specular reflection light were used to measure surfaces of the parts (that is, the part (1) in FIG. 7A and FIG. 7C and the parts (1) to (3) in FIG. 7B) in the negative electrode active material layer for which the resistance values were obtained and thus, the a* values in the L*a*b* color system based on JIS Z8781-4:2013 were measured. The results are shown in Table 1.

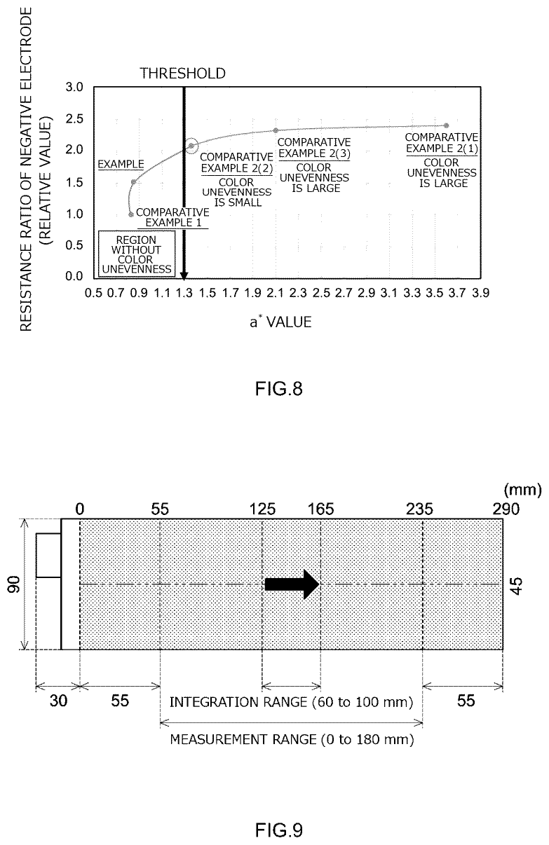

FIG. 8 expresses the relation between the a* value and the resistance ratio in the vicinity of the negative electrode tab of the negative electrode active material layer. As shown in FIG. 8, it has been understood that when the a* value is 1.3 or less, the vicinity of the negative electrode tab does not have the color unevenness and the resistance can be suppressed.

### Checking of Color Unevenness of Negative Electrode and Resistance Measurement

In the second measuring step (step 8b), first, the negative electrode (measurement sample) as illustrated in FIG. 9 was prepared. Then, a laser ablation ICP mass spectrometer was used to irradiate the sample with laser along the long side direction (width direction) from the vicinity of the negative electrode tab of the negative electrode active material layer and while making the sample at the laser irradiated part into microparticles, the ICP mass spectrometry was performed continuously. Note that the measurement range in the width direction was “measurement range (0 to 180 mm)” in FIG. 9. An arrow in FIG. 9 indicates a laser traveling direction.

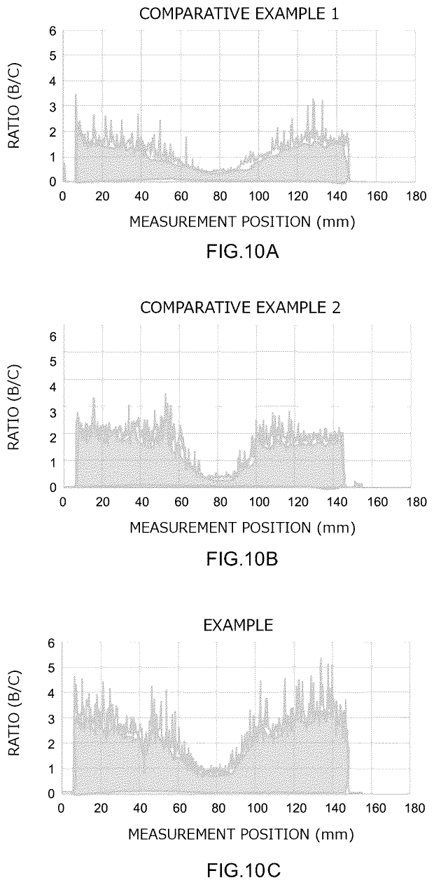

The ratio (B/C) of the amount of boron (B) element to the amount of carbon (C) element was obtained and a graph expressing the measurement position (mm) along the horizontal axis and the ratio (B/C) along the vertical axis was created. The distribution of the ratio (B/C) in Comparative Example 1 is shown in FIG. 10A, the distribution of the ratio (B/C) in Comparative Example 2 is shown in FIG. 10B, and the distribution of the ratio (B/C) in Example is shown in FIG. 10C. Table 1 also shows the values (integrated values) obtained by integration in the range of “integration range (0 to 100 mm)” in FIG. 9. As shown in Table 1, it has been understood that the integrated value of the ratio (B/C) was large relatively and the amount of B element increased in the central part of the negative electrode active material layer in Comparative Example 2 in which the pressurizing operation was repeated in the electrolyte solution impregnating step as compared to Comparative Example 1 in which only the depressurizing operation was performed in the electrolyte solution impregnating step. It has also been understood that in Example in which each of the pressurizing operation and the depressurizing operation was performed once in the electrolyte solution impregnating step, the integrated value of the ratio (B/C) was increased further and the amount of B element increased drastically in the central part of the negative electrode active material layer.

### Evaluation of the Amount of Heat Generation of Battery

First, a sample for DSC measurement was manufactured. Specifically, first, the positive electrode including the positive electrode active material layer (20 mm×20 mm square) and the negative electrode including the negative electrode active material layer (22 mm×22 mm square) were disposed to face each other through the separator and accommodated together with 0.4 mL of the nonaqueous electrolyte solution in the dry air (dew point: −50° C.) atmosphere; thus, a laminate cell was constructed. Next, the manufactured laminate cell was charged with constant current up to 4.25 V with a current value of 8 mA and then charged with constant voltage for five hours. Subsequently, the charged laminate cell was disassembled in a glove box (Ar atmosphere). Next, the electrolyte solution was extracted and additionally the positive electrode and the negative electrode were extracted, and then a positive electrode mixture was peeled from a central region of the positive electrode active material layer and a negative electrode mixture was peeled from a central region of the negative electrode active material layer. Then, 1 mg of the positive electrode mixture peeled from the positive electrode, 2 mg of the negative electrode mixture peeled from the negative electrode, and 4 mg of the extracted electrolyte solution were accommodated in a sample container. This sample container was sealed by pressing at 20 MPa, and then set to a differential scanning calorimetry (DSC) together with a standard material (Al₂O₃, 2 mg). Subsequently, the temperature was increased at a temperature increasing rate of 2° C./min from 25° C. to 350° C. under an inert atmosphere and the amount of heat generation (J) between 75 and 200° C. was obtained by integration. The results are shown in Table 1.

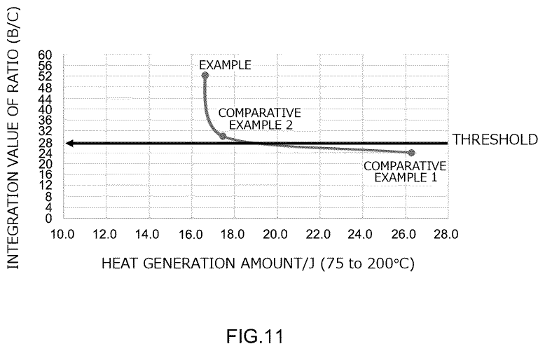

FIG. 11 shows a relation between the amount of heat generation of the battery and the integrated value of the ratio (B/C) of the central part of the negative electrode active material layer. As shown in FIG. 11, the correlation was recognized between the amount of heat generation of the battery and the integrated value of the ratio (B/C). That is to say, as the integrated value of the ratio (B/C) was larger, in other words, as the amount of B element was larger, the amount of heat generation of the battery was suppressed. Therefore, it has been understood that when the integrated value of the ratio (B/C) is 28 or more, the amount of heat generation can be suppressed to be small (for example, 20 J or less, preferably 18 J or less) and the thermal stability of the battery can be improved.

Although some embodiments of the present disclosure have been described above, these embodiments are just examples. The present disclosure can be implemented in various other modes. The present disclosure can be implemented based on the contents disclosed in this specification and the technical common sense in the relevant field. The techniques described in the scope of claims include those in which the embodiments exemplified above are variously modified and changed. For example, a part of the aforementioned embodiment can be replaced by another modified example, and the other modified example can be added to the aforementioned embodiment. Additionally, the technical feature may be deleted as appropriate unless such a feature is described as an essential element.

As described above, the following items are given as specific aspects of the art disclosed herein.
Item 1: The nonaqueous electrolyte solution secondary battery including the electrode body including the positive electrode and the negative electrode, the positive electrode terminal electrically connected to the positive electrode, the negative electrode terminal electrically connected to the negative electrode, and the nonaqueous electrolyte solution, in which the negative electrode includes the negative electrode active material layer containing the carbon material and having a width of 200 mm or more, and the plurality of negative electrode tabs provided at one end part in the width direction of the negative electrode active material layer, the plurality of negative electrode tabs are electrically connected to the negative electrode terminal in the state of being stacked and bent, when the root part of the negative electrode active material layer where the negative electrode tab extends is measured with the spectrometer, the a* value in the L*a*b* color system based on JIS Z8781-4:2013 is 1.3 or less, and the value obtained by measuring the amount of carbon element and the amount of boron element by the laser ablation ICP mass spectrometry along the width direction of the negative electrode active material layer and integrating the ratio (B/C) of the amount of boron element to the amount of carbon element in the range of ±20 mm from the center in the width direction is 28 or more.
Item 2: The nonaqueous electrolyte solution secondary battery according to Item 1, in which the electrode body is the wound electrode body in which the positive electrode with a band shape and the negative electrode with a band shape are stacked and wound in the insulated state.
Item 3: The nonaqueous electrolyte solution secondary battery according to Item 1 or 2, in which the width direction is the direction that coincides with the winding axis direction of the wound electrode body.
Item 4: The nonaqueous electrolyte solution secondary battery according to any one of Items 1 to 3, in which the nonaqueous electrolyte solution includes the compound containing the boron element.

What is claimed is:

1. A nonaqueous electrolyte solution secondary battery comprising:
an electrode body including a positive electrode and a negative electrode;
a positive electrode terminal electrically connected to the positive electrode;
a negative electrode terminal electrically connected to the negative electrode; and
a nonaqueous electrolyte solution, wherein
the negative electrode includes a negative electrode active material layer containing a carbon material and having a width of 200 mm or more, and a plurality of negative electrode tabs provided at one end part in a width direction,
the plurality of negative electrode tabs are electrically connected to the negative electrode terminal in a state of being stacked and bent,
when a root part of the negative electrode active material layer where the negative electrode tab extends is measured with a spectrometer, an a* value in an L*a*b* color system based on JIS Z8781-4:2013 is 1.3 or less, and
a value obtained by measuring the amount of carbon element and the amount of boron element by laser ablation ICP mass spectrometry along the width direction of the negative electrode active material layer and integrating a ratio (B/C) of the amount of boron element to the amount of carbon element in a range of ±20 mm from a center in the width direction is 28 or more.

2. The nonaqueous electrolyte solution secondary battery according to claim 1, wherein the electrode body is a wound electrode body in which the positive electrode with a band shape and the negative electrode with a band shape are stacked and wound in an insulated state.

3. The nonaqueous electrolyte solution secondary battery according to claim 2, wherein the width direction is a direction that coincides with a winding axis direction of the wound electrode body.

4. The nonaqueous electrolyte solution secondary battery according to claim 1, wherein the nonaqueous electrolyte solution includes a compound containing a boron element.
